(19) United States
(12) Patent Application Publication
(10) Pub. No.: US 2011/0236040 A1
(43) Pub. Date: Sep. 29, 2011

(54) IMAGE FORMING APPARATUS AND SHEET CARRYING METHOD FOR IMAGE FORMING APPARATUS

(75) Inventor: Norio TANAKA, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/033,561

(22) Filed: Feb. 23, 2011

Related U.S. Application Data
(60) Provisional application No. 61/318,706, filed on Mar. 29, 2010.

(51) Int. Cl. G03G 15/00

(52) U.S. Cl. 399/16; 399/21

(57) ABSTRACT

An image forming apparatus includes: a carrying unit which carries a sheet from a sheet supply unit toward a sheet discharge unit; a transfer unit which transfers an image to the sheet; a fixing unit which fixes the image transferred to the sheet by the transfer unit, at a second position in the carrying unit; an acquisition unit which acquires information about the size of the sheet at a third position upstream from the second position in the carrying direction in the carrying unit; and a control unit which controls the carrying unit when the size of the sheet accepted by the acceptance unit is different from the size of the sheet acquired by the acquisition unit, and thus carries the sheet to a fourth position where a rear end of the sheet in the carrying direction is situated downstream from the second position in the carrying direction.

This application is also based upon and claims the benefit of priority from U.S. provisional application 61/318706, filed on Mar. 29, 2010; the entire contents of which are incorporated herein by reference.

### FIELD

Embodiments described herein relate generally to an image forming apparatus having a function of carrying a sheet.

### BACKGROUND

Conventionally, in the case where the preset size of a sheet is different from the size of a sheet measured by a sensor, an image forming apparatus immediately enters a jam processing state when it is determined that the size is different.

However, if a sheet is stopped before a toner image transferred to the sheet is fixed, there is a risk that unfixed toner may adhere to operator' s hands when collecting the sheet.

### DESCRIPTION OF THE DRAWINGS

FIG. 1 is a sectional view of an image forming apparatus.

FIG. 2 is a functional block diagram of the image forming apparatus.

FIG. 3 is a flowchart showing procedures of a sheet carrying method.

FIG. 4 is a flowchart showing procedures of a carrying method for a subsequent sheet.

### DETAILED DESCRIPTION

Generally, according to an embodiment, an image forming apparatus includes: an acceptance unit which accepts designation information designating a size of a sheet on which an image is to be formed; a carrying unit which carries a sheet from a sheet supply unit which supplies the sheet, toward a sheet discharge unit to which the sheet is discharged; a transfer unit which transfers an image to the sheet at a first position in the carrying unit; a fixing unit which fixes the image transferred to the sheet by the transfer unit, at a second position downstream from the first position in a carrying direction in the carrying unit; an acquisition unit which acquires information about the size of the sheet carried toward the fixing unit, at a third position upstream from the second position in the carrying direction in the carrying unit; and a control unit which controls the carrying unit when the size of the sheet accepted by the acceptance unit is different from the size of the sheet acquired by the acquisition unit, and thus carries the sheet to a fourth position where a rear end of the sheet in the carrying direction is situated downstream from the second position in the carrying direction.

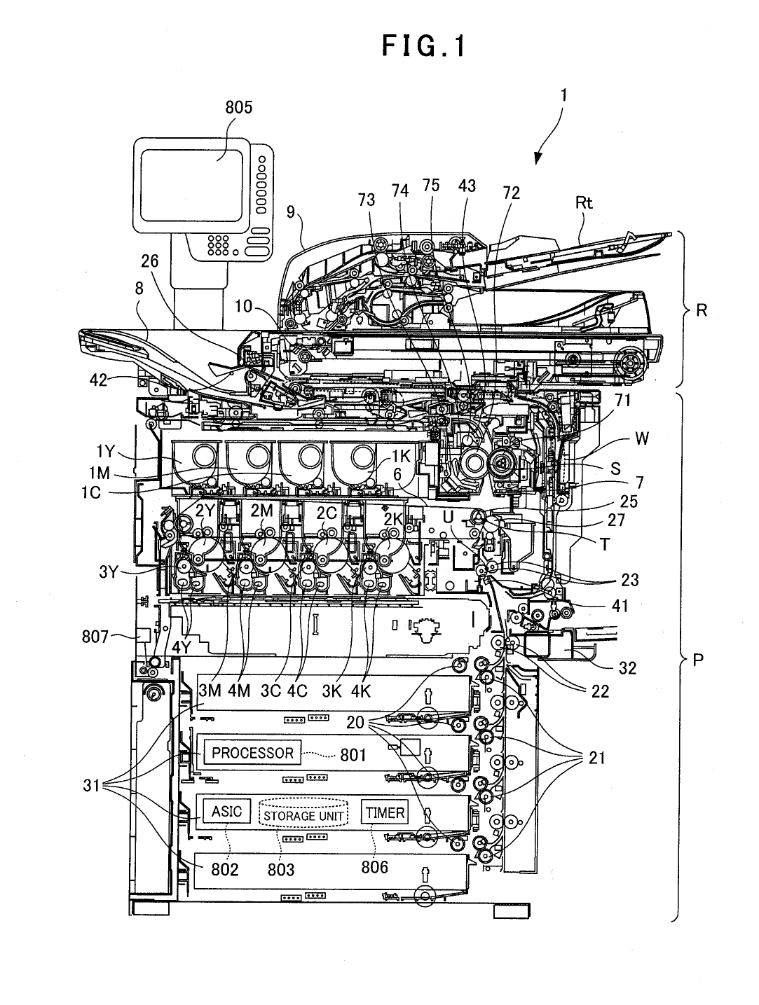

FIG. 1 is a sectional view of an image forming apparatus according to this embodiment. Referring to FIG. 1, an image forming apparatus 1 has an image reading unit R and an image forming unit P. The image reading unit R scans and reads an image of a sheet document and a book document.

The image forming unit P forms a developer image on a sheet based on an image read from a document by the image reading unit R or print data transmitted from external device to the image forming apparatus 1.

The image reading unit R has an automatic document feeder (ADF) 9 which automatically carries a document to a predetermined image reading position. The image reading unit R reads an image of a document placed on a document tray Rt automatically carried by the automatic document feeder 9 or a document placed on a document table, using a scanning optical system 10.

The image forming unit P has toner cartridges 1Y to 1K, photoconductive members 2Y to 2K, developing rollers 3Y to 3K, mixers 4Y to 4K, an intermediate transfer belt 6, a fixing device 7, cassette trays 31, a manual insertion tray 32, and a discharge tray 8.

There are plural cassette trays 31 and sheets of different sizes are stacked in respective cassette trays 31. The sheets placed in the cassette tray 31 are picked up one by one by a pickup roller 20 . The sheet picked up by the pickup roller 20 is carried to registration rollers 23 as first carrying rollers 21 and second carrying rollers 22 rotate.

The registration rollers 23 correct the skew of the sheet heading toward a secondary transfer position T where intermediate transfer of toner by the intermediate transfer belt 6 is carried out. Specifically, as the sheet is abutted against the registration rollers 23, the skew of the sheet is corrected.

A registration sensor 41 detects the size of the sheet abutted against the registration rollers 23. The detection method may be an optical method. The registration sensor 41 turns on when a sheet is detected, and turns off when no sheet is detected any longer. Therefore, the time the registration sensor 41 is on is measured to specify the size of the sheet in the carrying direction.

The fixing device 7 has a. pressurizing roller 71, a heating roller 72, a heating unit 73, a heating belt 74, and a tension roller 75. The pressurizing roller 71 rotates in contact with the heating belt 74. The heating roller 72, the heating belt 74 and the tension roller 75 rotate, following the pressurizing roller 71. The heating unit 73 has a coil. A high-frequency current applied to this coil generates a magnetic flux. The magnetic flux generated in the heating unit 73 induces an eddy-current on the heating belt 74 and the heating belt 74 generates heat. A fixing sensor 43 detects the sheet passed through a nip part between the pressurizing roller 71 and the heating roller 72. The detection method may be an optical method.

A discharge roller 26 discharges a sheet to which a toner image is fixed by the fixing device 7, to the discharge tray 8. The sheet discharged from the discharge roller 26 is detected by a discharge sensor 42.

The image forming apparatus 1 according to this embodiment also has a processor 801, an ASIC circuit 802, a storage unit 803, an operation display unit 805, a timer 806, and a communication unit 807. The timer 806 may be installed within the processor 801.

The processor 801 has the role of performing various kinds of processing in the image forming apparatus 1 and also has the role of realizing various functions by executing programs stored in the storage unit 803. The processor 801 may be a CPU or MPU. The processor 801 may also include the ASIC circuit 802. In this case, the ASIC circuit 802 executes at least part of the processing realized by the processor 801, in a circuit-based manner. The storage unit 803 may be, for example, a RAM (random access memory) , ROM (read only memory), DRAM (dynamic random access memory), or SRAM (static random access memory). The storage unit 803 stores various kinds of information necessary for executing flowcharts which will be described later.

Various settings are displayed on the operation display unit 805. The operation display unit 805 may be an LCD (liquid crystal display), EL (electronic luminescence) display, PDP (plasma display panel), or CRT (cathode ray tube).

The various settings are changed by operation on the operation display unit 805. The operation display unit 805 may be a touch-panel type.

The communication unit 807 receives a signal transmitted from a PC in which a printer driver is installed.

Hereinafter, an outline of copying will be described as an example of processing in the image forming apparatus according'to this embodiment.

First, a sheet picked up from the cassette tray 31 by the pickup roller 20 is carried to the registration rollers 23 as the first carrying rollers 21 and the second carrying rollers 22 rotate.

Then, an image of plural sheets of a sheet document that are continuously automatically carried by the automatic document feeder 9 is read by the scanning optical system 10 at the predetermined image reading position.

Next, based on print data of the image read from the document by the image reading unit R, electrostatic latent images are formed on the photoconductive surfaces of the photoconductive members 2Y, 2M, 2C and 2K for transferring developer images of yellow (Y) , magenta (M) , cyan (C) and black (K) to a sheet.

Subsequently, developers stirred by the mixers 4Y to 4K in the developing device are supplied by the developing rollers 3Y to 3K to the photoconductive members 2Y to 2K on which the electrostatic latent images are formed as described above. Thus, the electrostatic latent images formed on the photoconductive surfaces of the photoconductive members are developed.

The developer images thus formed on the photoconductive members are transferred to the belt surface of the intermediate transfer belt 6 (so-called primary transfer) . The developer images carried by the turning of the intermediate transfer belt are transferred onto the sheet carried from the registration rollers 23, at the secondary transfer position T.

The developer images transferred onto the sheet are heated and fixed to the sheet by the fixing device 7. The sheet to which the developer images are heated and fixed is carried through a carrying path by plural carrying roller pairs and is sequentially discharged onto the discharge tray 8.

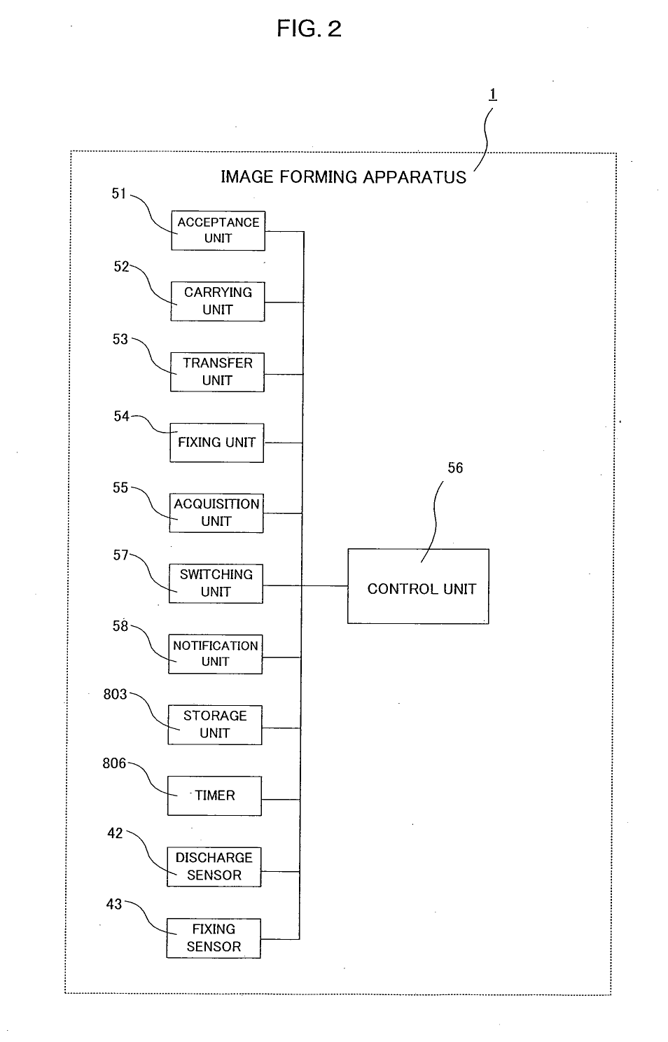

Next, FIG. 2 shows an exemplary functional block of the image forming apparatus according to this embodiment. The image forming apparatus 1 according to this embodiment includes an acceptance unit 51, a carrying unit 52, a transfer unit 53, a fixing unit 54, an acquisition unit 55, a control unit 56, a switching unit 57, and a notification unit 58.

The acceptance unit 51 accepts designation information designating the size of a sheet on which an image is to be formed by the image forming unit P. Here, the acceptance unit 51 may be the operation display unit 805. As a user operates the operation display unit 805, the size of a sheet on which an image is to be formed is decided. The acceptance unit 51 may also be the communication unit 807. The communication unit 807 accepts designation information about the size of a sheet that is inputted by a printer driver started up on a PC, not shown.

The carrying unit 52 carries a sheet supplied from the cassette tray 31 or the manual insertion tray 32 toward the discharge tray 8. The carrying unit 52 maybe plural carrying rollers. These carrying rollers may include the first carrying rollers 21, the second carrying rollers 22, the registration rollers 23, a belt driving roller 25, a transfer driven roller 27, the pressurizing roller 71, the heating roller 72, and the discharge roller 26.

The transfer unit 53 transfers an image to the sheet at the secondary transfer position T as a first position. The transfer unit 53 may include the intermediate transfer belt 6 and the belt driving roller 25.

The fixing unit 54 fixes the toner image transferred to the sheet by the fixing unit 53, at a fixing position (second position) S downstream from the second transfer position T in the carrying direction. The fixing unit 54 may be the fixing device 7.

The acquisition unit 55 acquires information about the size of the sheet carried toward the fixing position S, at a registration position (third position) U upstream from the fixing position S in the carrying direction in the carrying unit 52. The acquisition unit 55 may be the registration sensor 41. The acquisition unit 55 may also be another sensor situated upstream from the registration sensor 41 in the carrying direction. This another sensor may be an optical sensor that can acquire information about the size of the sheet.

The control unit 56 controls the carrying unit 52 when the size of the sheet accepted by the acceptance unit 51 is different from the size of the sheet acquired by the acquisition unit 55, so that the sheet is carried in a way that the rear end of the sheet in the carrying direction is situated downstream from the fixing position S in the carrying direction. The control unit 56 may be the processor 801. Since toner is fixed to the sheet of the different size, adherence of unfixed toner to the user at the time of disposal is restrained.

The switching unit 57 switches the stop position of the sheet between a position within the carrying path and a position outside the carrying path when the size of the sheet accepted by the acceptance unit 51 is different from the size of the sheet acquired by the acquisition unit 55. That is, the switching unit 57 switches the stop position of the sheet between a position within the carrying path at which the sheet stops in the state where the rear end of the sheet in the carrying direction is situated between the fixing unit 54 and the discharge roller 26 and a position outside the carrying path arranged on the discharge tray 8. The switching unit 57 may be the operation display unit 805. Information inputted via the operation display unit 805 is stored in the storage unit 803 as different-sheet processing setting information.

When the sheet stops at the position within the carrying path, the processor 801 switches the setting of the image forming apparatus 1 to a so-called jam processing state where the carrying by the carrying unit 52 is stopped. In this jam processing state, the forward end of the sheet in the carrying direction passes the discharge roller 26 and is situated on the discharge tray 8. The rear end of the sheet in the carrying direction is situated within the carrying path in the carrying unit 52. That is, since the sheet partly extends onto the discharge tray 8, the sheet is visually distinguished from a sheet that is completely discharged onto the discharge tray 8. Moreover, since the sheet is not pressurized by the pressurizing roller 71 and the heating roller 72, the jam processing is made easier.

The control unit 56 may prohibit a sheet subsequent to the above sheet (hereinafter referred to as a subsequent sheet) from advancing downstream from the registration rollers 23, by controlling the carrying unit 52 when the size of the sheet accepted by the acceptance unit 51 is different from the size of the sheet acquired by the acquisition unit 55.

The control unit 56 may prohibit the carrying of the subsequent sheet by stopping the rotation of the registration rollers 23. In this case, the rotation of the registration rollers 23 may be stopped when a sheet on the cassette tray 31 or the manual insertion tray 32 is picked up and then the size of the sheet is determined as different.

The control unit 56 may stop the carrying of the subsequent sheet by prohibiting the pickup of the subsequent sheet placed on the cassette tray 31 or the manual insertion tray 32. In this case, the carrying of the subsequent sheet may be stopped until it can be determined whether the size of the sheet is different or not. When the size of the sheet is the same, the carrying of the subsequent sheet is resumed. When the size of the sheet is different, the stop of the carrying of the subsequent sheet is continued.

The notification unit 58 notifies that the size of the sheet accepted by the acceptance unit 51 is different from the size of the sheet acquired by the acquisition unit 55. The notification unit 58 may be the operation display unit 805. The processor 801 performs control to display warning information on the operation display unit 805. The warning information may be a warning screen that notifies the user that jam processing is generated or a warning screen that notifies the user that a sheet of a different size from the preset size is discharged onto the discharge tray 8. The notification unit 58 may also be an audio output unit, not shown. The processor 801 controls the audio output unit to notify of the warning information.

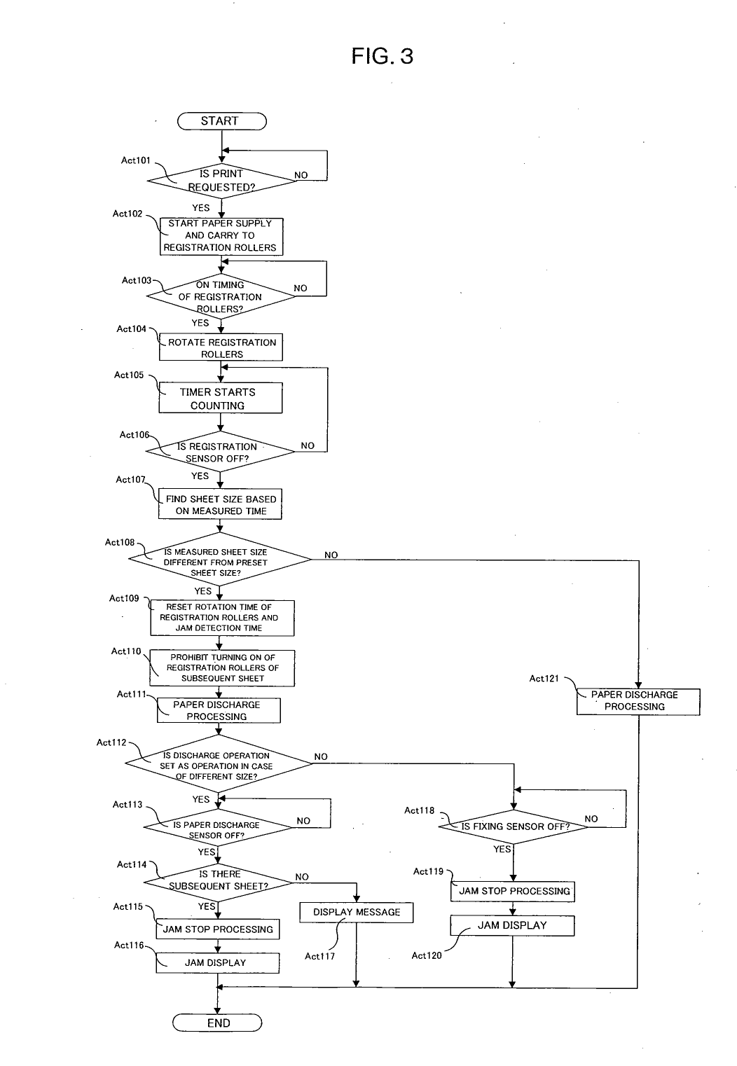

Next, the operation of the image forming apparatus 1 in the case where the size of the sheet accepted by the acceptance unit 51 is different from the size of the sheet acquired by the acquisition unit 55 will be described with reference to the flowchart of FIG. 3. In this flowchart, a subsequent sheet is abutted against the registration rollers 23 and is thus stopped.

In ACT 101, the processor 801 determines whether a signal indicating a print request is received by the acceptance unit 51 or not. The signal indicating the print request includes information about the selected size of the sheet (hereinafter referred to as size setting information). The processor 801 stores the size setting information included in the signal indicating the print request, in the storage unit 803, and goes to ACT 102.

In ACT 102, the processor 801 controls the driving of the first carrying rollers 21 and the second carrying rollers 22 so as to carry a sheet picked up from the cassette tray 31 toward the registration position U. The sheet reaching the registration position U is abutted against the registration rollers 23 and thus has its skew corrected.

In ACT 103, the processor 801 determines whether sheet carrying start timing is reached or not. This sheet carrying start timing is set in order to transfer a toner image formed on the intermediate transfer belt 6 to the sheet at the secondary transfer position T.

In ACT 104, when the sheet carrying start timing is reached, the processor 801 rotates the registration rollers 23. As the registration rollers 23 rotate, the carrying of the sheet stopped at the registration position U is resumed.

In ACT 105, the processor 801 stores the timing when the registration sensor 41 is turned on, that is, detection start timing when the rotation of the registration rollers 23 is started, in the storage unit 803, and causes the timer 806 to operate.

In ACT 106, the processor 801 stores the timing when the registration sensor 41 is turned off, that is, detection end timing when the rear end of the sheet in the carrying direction is detected by the registration sensor 41, in the storage unit 803, and stops the operation of the timer 806.

In ACT 107, the processor 801 calculates the size of the sheet in the carrying direction based on the detection start timing and the detection end timing stored in the storage unit 803 and stores the calculated size in the storage unit 803 as size measurement information.

In ACT 108, the processor 801 compares the size setting information and the size measurement information stored in the storage unit 803 and determines whether these sizes are different from each other or not. When the size setting information is different from the size measurement information, the processor 801 goes to ACT 109.

In ACT 109, the processor 801 resets the rotation time of the registration rollers 23 and the jam detection time according to the measured size of the sheet. The rotation time of the registration rollers 23 and the jam detection time are decided based on a preset sheet size. When the detected size of the sheet is different from the preset sheet size, it is conceivable that the rotation of the registration rollers 23 is stopped before the sheet passes the registration rollers 23, or the sheet is retained before the sheet passes the registration sensor 41, thus causing jam. Therefore, these times are reset based on the detected size of the sheet or a maximum sheet size that is allowable in the apparatus.

In ACT 110, the processor 801 stops the rotation of the registration rollers 23 and thus prohibits the subsequent sheet from being carried downstream from the registration rollers 23. As the subsequent sheet is abutted against the registration rollers 23 and retained there, transfer of toner to the subsequent sheet is prohibited.

In ACT 111, the processor 801 performs control to rotate the discharge roller 26. However, the discharge roller 26 may start being driven during the rotation of the registration rollers 23.

In ACT 112, the processor 801 reads out the different-sheet processing setting information from the storage unit 803 and determines whether this setting information is discharge operation setting or not.

When the setting information is discharge operation setting, the processor 801 determines in ACT 113 whether the discharge sensor 42 is turned off or not, that is, whether the rear end in the carrying direction of the sheet discharged to the discharge tray 8 is detected or not. Here, when the print setting mode is a double-side print mode, the sheet is prohibited from being sent back in a switchback-like manner to a double-side print path W indicated by a dotted line, and the sheet is discharged toward the discharge tray 8.

When the rear end of the sheet in the carrying direction is detected in ACT 113, the processor 801 goes to ACT 114. In ACT 114, the processor 801 determines whether the subsequent sheet is retained at the registration rollers 23 or not. When the subsequent sheet is retained at the registration rollers 23, the processor 801 goes to ACT 115.

In ACT 115, the processor 801 controls the driving of the carrying unit 52, thereby setting the image forming apparatus 1 in the jam processing state. In ACT 116, the processor 801 causes the notification unit 58 to notify that jam processing is generated.

When the subsequent sheet is not retained at the registration rollers 23 in ACT 114, the processor 801 goes to ACT 117. In ACT 117, the processor 801 causes the notification unit 58 that the size is different from the setting, and prompts the user to confirm and replace the sheet.

When the setting information is jam processing setting in ACT 112, the processor 801 goes to ACT 118. In ACT 118, the processor 801 determines whether the fixing sensor 43 is turned off or not , that is, whether the rear end in the carrying direction of the sheet discharged to the discharge tray 8 is detected or not.

When the rear end of the sheet in the carrying direction is detected in ACT 118, the processor 801 goes to ACT 119. In ACT 119, the processor 801 controls the driving of the carrying unit 52, thereby setting the image forming apparatus 1 in the jam processing state. In ACT 120, the processor 801 causes the notification unit 58 to notify that jam processing is generated.

When it is determined in ACT 108 that the size setting information and the size measurement information are the same, the processor 801 goes to ACT 121. In ACT 121, the processor 801 controls the driving of the carrying unit 52, thereby discharging the sheet to the discharge tray 8.

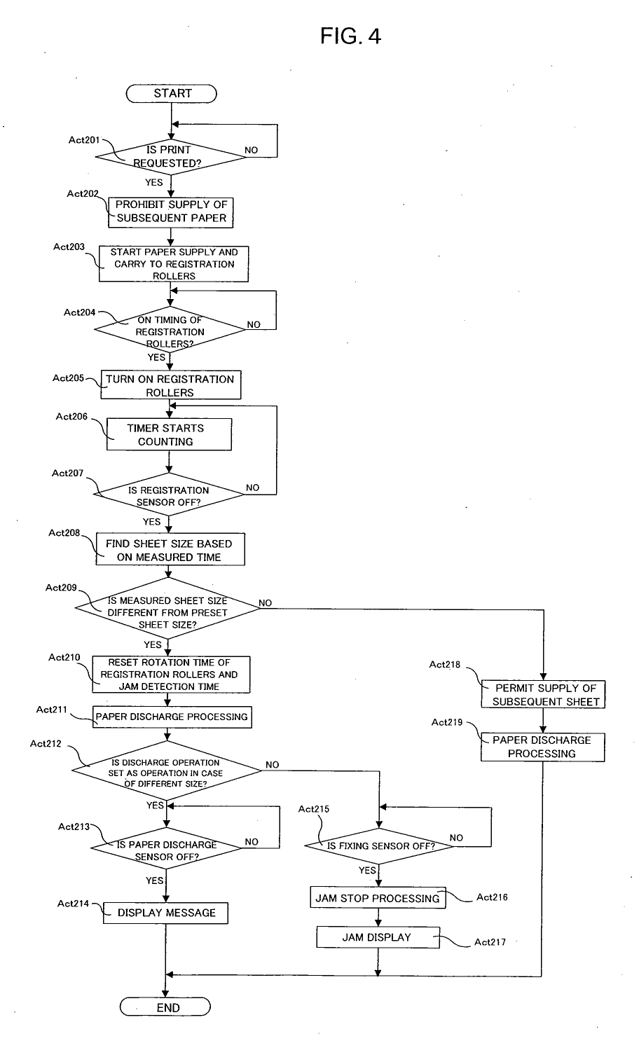

In ACT 110, the processor 801 stops the rotation of the registration rollers 23 and thus causes the subsequent sheet to be abutted against the registration rollers 23 and be retained there. However, pickup of the subsequent sheet from the cassette tray 31 may also be prohibited. An example of this case will be described in detail with reference to the flowchart of FIG. 4.

In ACT 201, the processor 801 determines whether a signal indicating a print request is received by the acceptance unit 51 or not. The signal indicating the print request includes information about the selected size of the sheet (hereinafter referred to as size setting information). The processor 801 stores the size setting information included in the signal indicating the print request, in the storage unit 803, and goes to ACT 202.

In ACT 202, when a preceding sheet is picked up from the cassette tray 31, the processor 801 immediately stops the operation of the pickup roller 20 and prohibits a subsequent sheet from being picked up from the cassette tray 31.

In ACT 203, the processor 801 controls the driving of the first carrying rollers 21 and the second carrying rollers 22 to carry the preceding sheet, picked up from the cassette tray 31, toward the registration position U. The preceding sheet reaching the registration position U is abutted against the registration rollers 23 and thus has its skew corrected.

In ACT 204, the processor 801 determines whether sheet carrying start timing is reached or not. This sheet carrying start timing is set in order to transfer a toner image formed on the intermediate transfer belt 6 to the sheet at the secondary transfer position T.

In ACT 205, when the sheet carrying start timing is reached, the processor 801 rotates the registration rollers 23. As the registration rollers 23 rotate, the carrying of the sheet stopped at the registration position U is resumed.

In ACT 206, the processor 801 stores the timing when the registration sensor 41 is turned on, that is, detection start timing when the rotation of the registration rollers 23 is started, in the storage unit 803, and causes the timer 806 to operate.

In ACT 207, the processor 801 stores the timing when the registration sensor 41 is turned off, that is, detection end timing when the rear end of the sheet in the carrying direction is detected by the registration sensor 41, in the storage unit 803, and stops the operation of the timer 806.

In ACT 208, the processor 801 calculates the size of the sheet in the carrying direction based on the detection start timing and the detection end timing stored in the storage unit 803 and stores the calculated size in the storage unit 803 as size measurement information.

In ACT 209, the processor 801 compares the size setting information and the size measurement information stored in the storage unit 803 and determines whether these sizes are different from each other or not. When the size setting information is different from the size measurement information, the processor 801 goes to ACT 210.

In ACT 210, the processor 801 resets the rotation time of the registration rollers 23 and the jam detection time according to the measured size of the sheet.

In ACT 211, the processor 801 performs control to rotate the discharge roller 26. In ACT 212, the processor 801 reads out the different-sheet processing setting information from the storage unit 803 and determines whether this setting information is discharge operation setting or not.

When the setting information is discharge operation setting, the processor 801 determines in ACT 213 whether the discharge sensor 42 is turned off or not, that is, whether the rear end in the carrying direction of the sheet discharged to the discharge tray 8 is detected or not. Here, when the print setting mode is a double-side print mode, the sheet is prohibited from being sent back in a switchback-like manner, and the sheet is discharged toward the discharge tray 8.

When the rear end of the sheet in the carrying direction is detected in ACT 213, the processor 801 goes to ACT 214. In ACT 214, the processor 801 causes the notification unit 58 that the size is different from the setting, and prompts the user to confirm and replace the sheet.

When the setting information is jam processing setting in ACT 212, the processor 801 goes to ACT 215. In ACT 215, the processor 801 determines whether the fixing sensor 43 is turned off or not, that is, whether the rear end in the carrying direction of the sheet discharged to the discharge tray 8 is detected or not.

When the rear end of the sheet in the carrying direction is detected in ACT 215, the processor 801 goes to ACT 216. In ACT 216, the processor 801 controls the driving of the carrying unit 52, thereby setting the image forming apparatus 1 in the jam processing state. In ACT 217, the processor 801 causes the notification unit 58 to notify that jam processing is generated. When jam processing is determined, the sheet always remains within the image forming apparatus 1 and therefore the operation to remove the sheet is required in the case of carrying out next print. To stop the operation for jam processing, the display on the operation display unit 805 may be similar to the display that is shown when other jam processing is generated. This display is for operation setting to discharge the sheet outside of the image forming apparatus 1 and is different from the information displayed when the sheet size is mistaken. However, messages and jam processing procedures related to jam processing corresponding to each type of jam may be displayed. Thus, the user learns the cause of the generation of jam processing and a method for canceling the jam. The display notifying the generation of the jam may include not only the display on the operation display unit 805 but also more powerful measures to notify the user with light-emitting information via LED or audio output. In this case, it is easier to make the user recognize that certain abnormality is generated in the image forming apparatus 1.

### Modification 1

The switching unit 57 may be omitted. When the switching unit 57 is omitted, either a position within the carrying path where the sheet is stopped so that the rear end of the sheet in the carrying direction is situated between the fixing unit 54 and the discharge roller 26, or a position outside the carrying path arranged on the discharge tray 8 is set as the sheet stop position.

While certain embodiments have been described, these embodiments have been presented by way of example only, and are not intended to limit the scope of invention. Indeed, the novel apparatus described herein may be embodied in a variety of other forms; furthermore, various omissions, substitutions and changes in the form of the apparatus described herein may be made without departing from the sprit of the inventions. The accompanying claims and their equivalents are intended to cover such forms or modificat-ions as would fall within the scope and spirit of the inventions.

What is claimed is:

1. An image forming apparatus comprising:
an acceptance unit which accepts designation information designating a size of a sheet on which an image is to be formed;
a carrying unit which carries a sheet from a sheet supply unit which supplies the sheet, toward a sheet discharge unit to which the sheet is discharged;
a transfer unit which transfers an image to the sheet at a first position in the carrying unit;
a fixing unit which fixes the image transferred to the sheet by the transfer unit, at a second position downstream from the first position in a carrying direction in the carrying unit;
an acquisition unit which acquires information about the size of the sheet carried toward the fixing unit, at a third position upstream from the second position in the carrying direction in the carrying unit; and
a control unit which controls the carrying unit when the size of the sheet accepted by the acceptance unit is different from the size of the sheet acquired by the acquisition unit, and thus carries the sheet to a fourth position where a rear end of the sheet in the carrying direction is situated downstream from the second position in the carrying direction.

2. The apparatus according to claim 1, wherein the fourth position is situated between the sheet discharge unit and the second position.

3. The apparatus according to claim 2, further comprising a notification unit,
wherein the control unit controls the notification unit when the sheet is carried to the fourth position, thereby notifying of jam processing information indicating that the sheet is situated within the carrying unit.

4. The apparatus according to claim 1, wherein the fourth position is situated on the sheet discharge unit.

5. The apparatus according to claim 1, further comprising a switching unit which switches the fourth position between a position within a carrying path that is between the sheet discharge unit and the second position, and a position outside the carrying path that is on the sheet discharge unit.

6. The apparatus according to claim 5, further comprising a notification unit,
wherein in the case where the switching unit is set to the position within the carrying path, the control unit controls the notification unit when the sheet is carried to the fourth position, thereby notifying of jam processing information indicating that the sheet is situated within the carrying unit.

7. The apparatus according to claim 1, wherein the acquisition unit is a registration sensor which detects the size of the sheet when the sheet passes a registration roller which corrects a skew of the sheet.

8. The apparatus according to claim 1, wherein the control unit controls the carrying unit when the size of the sheet accepted by the acceptance unit is different from the size of the sheet acquired by the acquisition unit, thereby prohibiting a subsequent sheet from being carried to the transfer unit.

9. The apparatus according to claim 8, further comprising a registration roller which is situated upstream from the transfer unit in the carrying direction and corrects a skew of the sheet,
wherein the control unit prohibits rotation of the registration roller, thereby prohibiting the subsequent sheet from being carried.

10. The apparatus according to claim 8, further comprising a pickup roller which picks up the sheet from the sheet supply unit,
wherein the control unit prohibits pickup by the pickup roller, thereby prohibiting the subsequent sheet from being carried.

11. The apparatus according to claim 1, wherein when the designation information includes information designating double-side print,
the control unit controls the carrying unit, thereby prohibiting the sheet from moving toward a path for carrying out double-side print.

12. The apparatus according to claim 11, wherein the control unit carries the sheet to a position where at least a forward end of the sheet in the carrying direction is situated on the sheet discharge unit.

13. A sheet carrying method for an image forming apparatus comprising:
accepting designation information designating a size of a sheet on which an image is to be formed;
carrying a sheet from a sheet supply unit which supplies the sheet, toward a sheet discharge unit to which the sheet is discharged;
transferring an image to the sheet at a first position in a carrying path for the sheet;
fixing the image transferred to the sheet at a second position downstream from the first position in a carrying direction in the carrying path;
acquiring information about the size of the sheet carried toward the second position, at a third position upstream from the second position in the carrying direction in the carrying path; and
carrying the sheet to a fourth position where a rear end of the sheet in the carrying direction is situated downstream from the second position in the carrying direction when the size of the sheet in the designation information is different from the acquired size of the sheet.

14. The method according to claim 13, wherein the fourth position is situated between the sheet discharge unit and the second position.

15. The method according to claim 14, wherein when the sheet is carried to the fourth position, jam processing information indicating that the sheet is situated within the carrying unit is notified of.

16. The method according to claim 13, wherein the fourth position is situated on the sheet discharge unit.

17. The method according to claim 13, wherein when the sheet passes a registration roller which corrects a skew of the sheet, the size of the sheet is acquired from a registration sensor which detects the size of the sheet.
